(19) United States
(12) Patent Application Publication
(10) Pub. No.: US 2026/0045219 A1
(43) Pub. Date: Feb. 12, 2026

(54) DRIVING METHOD FOR DISPLAY PANEL, DRIVING CIRCUIT, AND DISPLAY DEVICE

(71) Applicant: HKC CORPORATION LIMITED, Baoan District (CN)

(72) Inventors: Bin QIU, Shenzhen (CN); Pei XU, Shenzhen (CN)

(21) Appl. No.: 19/293,261

(22) Filed: Aug. 7, 2025

(30) Foreign Application Priority Data
Aug. 9, 2024 (CN) 202411089090.6

(51) Int. Cl. G09G 3/3233; G09G 3/36

(52) U.S. Cl. CPC G09G 3/3233; G09G 3/3607; G09G 2300/0804; G09G 2300/0852; G09G 2300/0861; G09G 2310/0251; G09G 2310/0286; G09G 2340/0435

(57) ABSTRACT

A driving method for a display panel, a driving circuit, and a display device are provided. The driving method includes: determining a grayscale of each sub-pixel in each row of sub-pixels, to obtain charging time of each sub-pixel in each row of sub-pixels; and determining a first pre-charging duration of a target row of sub-pixels according to the charging time of each sub-pixel in a previous row of sub-pixels and the charging time of each sub-pixel in the target row of sub-pixels, where the first pre-charging duration is a duration for charging the target row of sub-pixels while charging the previous row of sub-pixels.

### CROSS-REFERENCE TO RELATED APPLICATIONS

This application claims priority under 35 U.S.C. § 119 (a) to Chinese Patent Application No. 202411089090.6, filed Aug. 9, 2024, the entire disclosure of which is incorporated herein by reference.

### TECHNICAL FIELD

This disclosure relates to the field of display technology, in particular to a driving method for a display panel, a driving circuit, and a display device.

### BACKGROUND

With the development and progress of display technology, compared to liquid crystal displays (LCD), organic light-emitting diodes (OLED) have advantages of free from backlight, high contrast, self-luminescence, fast response, wide viewing angle, high brightness, bright colors, light weight, applicable to flexible panels, wide operating temperature range, simpler structure and manufacturing process. Therefore, OLED is considered to be the next generation display technology.

In an OLED display, each sub-pixel includes two transistors (T) and a storage capacitor (C). The two transistors include a scan transistor and a driving transistor. The scan transistor is used as a switch for addressing, and the driving transistor provides a driving current for the OLED. The storage capacitor can store the image data voltage input to the sub-pixel during addressing, to maintain continuous emission of light of the sub-pixel in the frame period. When the display is operating, a gating pulse (i.e., a scan signal) is applied to the scan line to turn on the scan transistor, and the data voltage on the data line is applied to charge the storage capacitor. The voltage on the storage capacitor controls the operating state of the driving transistor and the current flowing through the OLED. During application of a non-selection signal to the scan line, the storage capacitor maintains the operation of the driving transistor.

However, existing OLED displays or LCD displays are charged through progressive scanning, and thus for each row, the scan time is the same and the scan method is fixed. For different data, the scan method is not flexible, resulting in a long time for scanning one frame and a low data transmission rate.

### SUMMARY

In a first aspect, the present application provides a driving method for a display panel. The driving method is applicable to the display panel including multiple rows of sub-pixels. The driving method includes: determining a grayscale of each sub-pixel in each row of sub-pixels, to obtain charging time of each sub-pixel in each row of sub-pixels; and determining a first pre-charging duration of a target row of sub-pixels according to the charging time of each sub-pixel in a previous row of sub-pixels and the charging time of each sub-pixel in the target row of sub-pixels, where the first pre-charging duration is a duration for charging the target row of sub-pixels while charging the previous row of sub-pixels.

In a second aspect, the present application further provides a driving circuit. The driving circuit is configured to execute steps in the driving method for the display panel as described in the first aspect, to drive the display panel to display.

In a third aspect, the present application further provides a display device. The display device includes a display panel and the driving circuit as described in the second aspect. The driving circuit is electrically connected to the display panel and is configured to drive the display panel to display.

### BRIEF DESCRIPTION OF THE DRAWINGS

To more clearly illustrate implementations of the present application or technical solutions in the related art, the drawings required for use in the implementations or the description of the related art will be briefly introduced below. Obviously, the drawings described below are merely some implementations of the present application. For ordinary skilled in the art, other drawings can be obtained based on the drawings without any creative effort.

FIG. 1 is a timing diagram of a scan signal in a driving method for a display panel in the related art.

FIG. 2 is a flow chart of a driving method for a display panel according to an implementation of the present application.

FIG. 3 is a flow chart of details of S200 in FIG. 2.

FIG. 4 is a flow chart of details of S230 in FIG. 3.

FIG. 5 is a timing diagram of a scan signal in a driving method for a display panel according to some implementations of the present application.

FIG. 6 is a flow chart of details of S100 in FIG. 2.

FIG. 7 is a schematic diagram of a circuit structure of a sub-pixel according to an implementation of the present application.

FIG. 8 is a flow chart of a driving method for a display panel according to another implementation of the present application.

FIG. 9 is a flow chart of details of S300 in FIG. 8.

FIG. 10 is a flow chart of details of S330 in FIG. 9.

FIG. 11 is a timing diagram of a scan signal in a driving method for a display panel according to some implementations of the present application.

FIG. 12 a is timing diagram of a scan signal in a driving method for a display panel according to some implementations of the present application.

### DETAILED DESCRIPTION

The following will be combined with the drawings in implementations of the present application to clearly and completely describe technical solutions in the implementations of the present application. Obviously, the described implementations are merely part of the implementations of the present application, rather than of the implementations. Based on the implementations in the present application, all other implementations obtained by ordinary skilled in the field without creative work are within the scope of protection of the present application.

It should be noted that when a component is considered to be “fixed to” another component, it can be directly on the other component or there can be an intervening component. When a component is considered to be “connected to” another component, it can be directly connected to the other component or there can be an intervening component.

Unless otherwise defined, all technical and scientific terms used in the present application have the same meaning as those commonly understood by those skilled in the art to which the present application belongs. The terms used in the present application and in the specification are merely for the purpose of describing specific embodiments and are not intended to limit the present application. The term “and/or” used in the present application includes any and all combinations of one or more of the related listed items.

In conjunction with the accompanying drawings, some implementations of the present application are described in detail below. In the absence of conflict, the following embodiments and features in the embodiments can be combined with each other.

The present application aims to provide a driving method for a display panel, a driving circuit, and a display device, to solve the problems of long scan time and low data transmission rate of the display device.

To achieve the purpose of the present application, the present application provides the following technical solutions. The present application provides a driving method for a display panel. The driving method is applicable to the display panel including multiple rows of sub-pixels. The driving method includes: determining a grayscale of each sub-pixel in each row of sub-pixels, to obtain charging time of each sub-pixel in each row of sub-pixels; and determining a first pre-charging duration of a target row of sub-pixels according to the charging time of each sub-pixel in a previous row of sub-pixels and the charging time of each sub-pixel in the target row of sub-pixels, where the first pre-charging duration is a duration for charging the target row of sub-pixels while charging the previous row of sub-pixels.

In an implementation, each sub-pixel in the previous row of sub-pixels is in one-to-one correspondence with each sub-pixel in the target row of sub-pixels. Determining the first pre-charging duration of the target row of sub-pixels according to the charging time of each sub-pixel in the previous row of sub-pixels and the charging time of each sub-pixel in the target row of sub-pixels includes: determining whether the grayscale of each sub-pixel in the previous row of sub-pixels is the same as the grayscale of each corresponding sub-pixel in the target row of sub-pixels; determining the first pre-charging duration of each sub-pixel in the target row of sub-pixels to be the charging time of each corresponding sub-pixel in the previous row of sub-pixels, when the grayscale of each sub-pixel in the previous row of sub-pixels is the same as the grayscale of each corresponding sub-pixel in the target row of sub-pixels; and determining the first pre-charging duration of the target row of sub-pixels according to charging time of a sub-pixel with a maximum grayscale in the previous row of sub-pixels and charging time of a sub-pixel with a minimum grayscale in the target row of sub-pixels, when a grayscale of a sub-pixel in the previous row of sub-pixels is different from a grayscale of a corresponding sub-pixel in the target row of sub-pixels.

In an implementation, determining the first pre-charging duration of the target row of sub-pixels according to the charging time of the sub-pixel with the maximum grayscale in the previous row of sub-pixels and the charging time of the sub-pixel with the minimum grayscale in the target row of sub-pixels includes: comparing the maximum grayscale of the previous row of sub-pixels with the minimum grayscale of the target row of sub-pixels; determining the first pre-charging duration of each sub-pixel in the target row of sub-pixels to be the charging time of the sub-pixel with the maximum grayscale in the previous row of sub-pixels, when the maximum grayscale of the previous row of sub-pixels is less than or equal to the minimum grayscale of the target row of sub-pixels; and determining the first pre-charging duration of each sub-pixel in the target row of sub-pixels to be the charging time of the sub-pixel with the minimum grayscale in the target row of sub-pixels, when the maximum grayscale of the previous row of sub-pixels is greater than the minimum grayscale of the target row of sub-pixels.

In an implementation, the driving method further includes: determining a second pre-charging duration of a next row of sub-pixels according to the charging time of each sub-pixel in the previous row of sub-pixels, the charging time of each sub-pixel in the target row of sub-pixels, and the charging time of each sub-pixel in the next row of sub-pixels, where the second pre-charging duration is a duration for charging the next row of sub-pixels while charging the previous row of sub-pixels.

In an implementation, each sub-pixel in the previous row of sub-pixels, each sub-pixel in the target row of sub-pixels, and each sub-pixel in the next row of sub-pixels are in one-to-one correspondence. Determining the second pre-charging duration of the next row of sub-pixels according to the charging time of each sub-pixel in the previous row of sub-pixels, the charging time of each sub-pixel in the target row of sub-pixels, and the charging time of each sub-pixel in the next row of sub-pixels includes: determining whether the grayscale of each sub-pixel in the target row of sub-pixels is the same as the grayscale of each corresponding sub-pixel in the previous row of sub-pixels, when the grayscale of each sub-pixel in the previous row of sub-pixels is the same as the grayscale of each corresponding sub-pixel in the next row of sub-pixels; determining the second pre-charging duration of each sub-pixel in the next row of sub-pixels to be the charging time of each corresponding sub-pixel in the previous row of sub-pixels, when the grayscale of each sub-pixel in the target row of sub-pixels is the same as the grayscale of each corresponding sub-pixel in the previous row of sub-pixels; and determining the second pre-charging duration of the next row of sub-pixels according to charging time of a sub-pixel with a maximum grayscale in the previous row of sub-pixels and charging time of a sub-pixel with a minimum grayscale in the target row of sub-pixels, when a grayscale of a sub-pixel in the target row of sub-pixels is different from a grayscale of a corresponding sub-pixel in the previous row of sub-pixels.

In an implementation, determining the second pre-charging duration of the next row of sub-pixels according to the charging time of the sub-pixel with the maximum grayscale in the previous row of sub-pixels and the charging time of the sub-pixel with the minimum grayscale in the target row of sub-pixels includes: comparing the maximum grayscale of the previous row of sub-pixels with the minimum grayscale of the target row of sub-pixels; determining the second pre-charging duration of each sub-pixel in the next row of sub-pixels to be the charging time of each corresponding sub-pixel in the previous row of sub-pixels, when the maximum grayscale of the previous row of sub-pixels is less than or equal to the minimum grayscale of the target row of sub-pixels; and determining the second pre-charging duration of each sub-pixel in the next row of sub-pixels to be the charging time of the sub-pixel with the minimum grayscale in the target row of sub-pixels, when the maximum grayscale of the previous row of sub-pixels is greater than the minimum grayscale of the target row of sub-pixels.

In an implementation, determining the grayscale of each sub-pixel in each row of sub-pixels, to obtain the charging time of each sub-pixel in each row of sub-pixels includes: determining a data voltage of each sub-pixel in each row of sub-pixels according to the grayscale of each sub-pixel in each row of sub-pixels; and determining the charging time of each sub-pixel according to a pre-stored capacitance value of a storage capacitor of each sub-pixel in each row of sub-pixels, a power supply voltage of each sub-pixel in each row of sub-pixels, and a charging current of each sub-pixel in each row of sub-pixels.

In an implementation, the charging time of each sub-pixel is determined according to the pre-stored capacitance value of the storage capacitor of each sub-pixel in each row of sub-pixels, the power supply voltage of each sub-pixel in each row of sub-pixels, and the charging current of each sub-pixel in each row of sub-pixels, by using the following formula:

t=(VDD−Vdata)×C/I,

where t is the charging time of each sub-pixel, VDD is the power supply voltage of each sub-pixel in each row of sub-pixels, Vdata is the data voltage of each sub-pixel, C is the capacitance value of the storage capacitor of each sub-pixel in each row of sub-pixels, and I is the charging current of each sub-pixel in each row of sub-pixels.

The present application further provides a driving circuit. The driving circuit is configured to execute steps in the driving method for the display panel as described above, to drive the display panel to display.

The present application further provides a display device. The display device includes a display panel and the driving circuit as described above. The driving circuit is electrically connected to the display panel and is configured to drive the display panel to display.

In the driving method for the display panel provided in the present application, the charging time of each row of sub-pixels is analyzed in advance according to image data of a picture to be displayed, and the first pre-charging duration of the target row of sub-pixels is determined according to the charging time of each sub-pixel in the previous row of sub-pixels and the charging time of each sub-pixel in the target row of sub-pixels. Therefore, the target row of sub-pixels can be pre-charged while the previous row of sub-pixels is charged, thereby reducing the scan time of the target row of sub-pixels and improving the data transmission rate.

In the related art, the refresh rate of organic light-emitting diodes (OLED) display panels is limited to about 360 Hz at most, and the main factor limiting the refresh rate is the charging duration of the storage capacitor in the sub-pixel. Specifically, as the display resolution and refresh rate increase, the scan duration of each scan line is limited, which leads to the limited charging duration of each row of sub-pixels. To ensure a good display effect, it is necessary to ensure that each sub-pixel can get enough charging duration. In existing display devices, the time allocated for each frame of picture is the same, and for one frame of picture, the scan duration of each scan line is also the same.

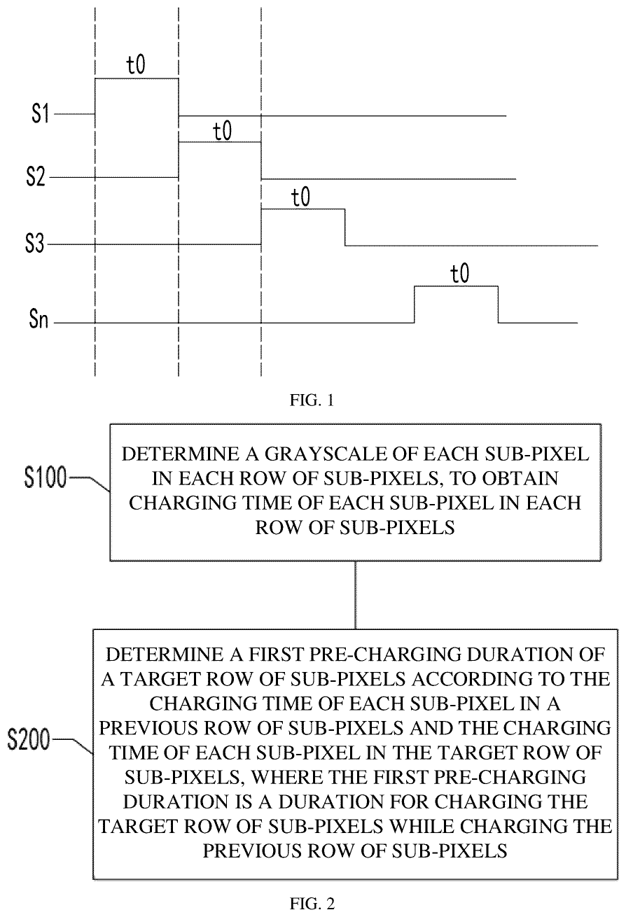

Referring to FIG. 1, S1 to Sn are scan signals transmitted through the 1st to n-th scan lines S, and the scan duration of each scan line S is to. However, for some sub-pixels with relatively low grayscales in the display frame, their required charging durations may be less than t0, which will lead to a waste of scan duration and limit the improvement of the refresh rate. For example, in the existing driving method for the display panel, the scan duration of each scan line S is t0, so the display duration of one frame of display picture is n×t0, that is, the refresh rate is 1/(n×t0).

Embodiments of the present application provide a driving method for a display panel. The driving method is applied to a driving circuit. The display panel includes n scan lines S extending in a row direction and n rows of sub-pixels that are in one-to-one correspondence with the n scan lines S, where n is greater than 1.

Referring to FIG. 2, the driving method includes the following steps.

S100, a grayscale of each sub-pixel in each row of sub-pixels is determined, to obtain charging time of each sub-pixel in each row of sub-pixels. The grayscale of the sub-pixel refers to a different brightness level that each sub-pixel can exhibit, and these levels are divided into several parts from the darkest (black) to the brightest (white) and each part represents a grayscale level. The number of the grayscales decides the fineness of the effect of the picture that the display can present. Generally, the brightness is divided into 256 grayscales from black to brightest, with grayscale 255 being the brightest and grayscale 0 being the darkest. The charging time of sub-pixels of different grayscales is different, specifically, the larger the grayscale, the longer the charging time.

S200, a first pre-charging duration of a target row of sub-pixels is determined according to the charging time of each sub-pixel in a previous row of sub-pixels and the charging time of each sub-pixel in the target row of sub-pixels, where the first pre-charging duration is a duration for charging the target row of sub-pixels while charging the previous row of sub-pixels.

The first pre-charging duration can be understood as a duration in which the previous row of sub-pixels and the target row of sub-pixels are charged simultaneously.

In LCD and OLED, each pixel is generally composed of three sub-pixels, that is, red sub-pixel (R), green sub-pixel, (G) and blue sub-pixel (B). These three sub-pixels are combined to produce a variety of different colors by controlling their brightness and color. Each sub-pixel has an independent driving circuit to control its brightness. By precisely controlling the brightness of the three sub-pixels, almost any color can be synthesized.

In the driving method for the display panel provided in the present application, the charging time of each row of sub-pixels is analyzed in advance according to image data of a picture to be displayed, and the first pre-charging duration of the target row of sub-pixels is determined according to the charging time of each sub-pixel in the previous row of sub-pixels and the charging time of each sub-pixel in the target row of sub-pixels. Therefore, the target row of sub-pixels can be pre-charged while the previous row of sub-pixels is charged, thereby reducing the scan time of the target row of sub-pixels and improving the data transmission rate.

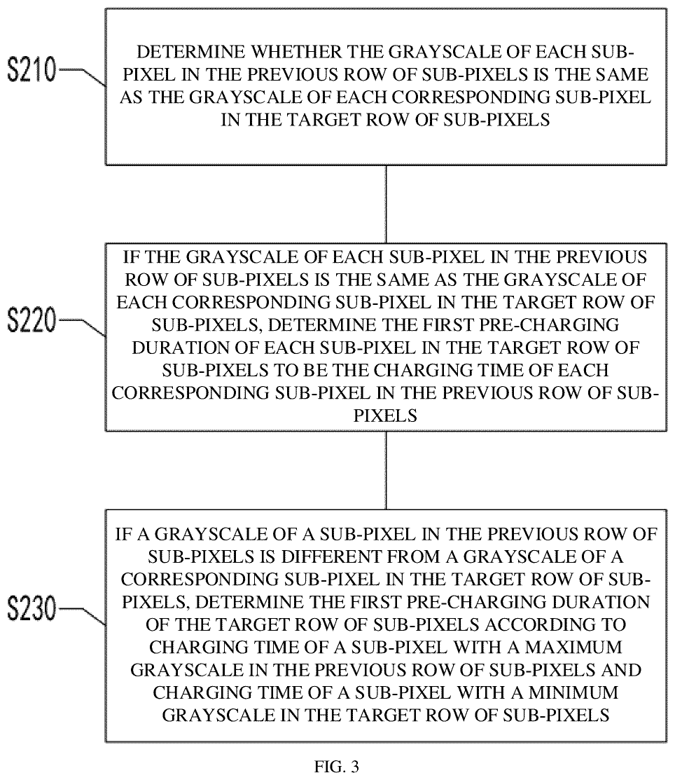

Referring to FIG. 3, S200 includes detailed steps: S210, S220, and S230.

S210, whether the grayscale of each sub-pixel in the previous row of sub-pixels is the same as the grayscale of each corresponding sub-pixel in the target row of sub-pixels is determined.

S220, if the grayscale of each sub-pixel in the previous row of sub-pixels is the same as the grayscale of each corresponding sub-pixel in the target row of sub-pixels, the first pre-charging duration of each sub-pixel in the target row of sub-pixels is determined to be the charging time of each corresponding sub-pixel in the previous row of sub-pixels.

S230, if a grayscale of a sub-pixel in the previous row of sub-pixels is different from a grayscale of a corresponding sub-pixel in the target row of sub-pixels, the first pre-charging duration of the target row of sub-pixels is determined according to charging time of a sub-pixel with a maximum grayscale in the previous row of sub-pixels and charging time of a sub-pixel with a minimum grayscale in the target row of sub-pixels.

In other words, if not all grayscales of sub-pixels in the previous row of sub-pixels are the same as all grayscales of corresponding sub-pixels in the target row of sub-pixels, the determining in S230 is performed.

Specifically, the display panel includes n scan lines S extending in a row direction and arranged in a column direction, m data lines D extending in the column direction and arranged in the row direction, and multiple sub-pixels defined by intersections of the n scan lines S and the m data lines D, where n is greater than 1 and m is greater than 1, for example, n=1080, m=3×1920. The sub-pixels in the previous row of sub-pixels are in one-to-one correspondence with the sub-pixels in the target row of sub-pixels. That is, in the previous row of sub-pixels and the target row of sub-pixels, the sub-pixel at the first column in the previous row of sub-pixels corresponds to the sub-pixel at the first column in the target row of sub-pixels, the sub-pixel at the second column in the previous row of sub-pixels corresponds to the sub-pixel at the second column in the target row of sub-pixels, the sub-pixel at the third column in the previous row of sub-pixels corresponds to the sub-pixel at the third column in the target row of sub-pixels, and so on.

S220 is the first case for two adjacent rows of sub-pixels in embodiments of the present application, as shown in Table 1.

TABLE 1

| | | | | |
|---|---|---|---|---|
| (1, 1)-G35 | (1, 2)-G42 | . . . | (1, n)-G48 | Max (1, 1~n)-G48 |
| | | | | Min (1, 1~n)-G23 |
| (2, 1)-G35 | (2, 2)-G42 | . . . | (2, n)-G48 | Max (2, 1~n)-G48 |
| | | | | Min (2, 1~n)-G23 |

In the first case for two adjacent rows of sub-pixels, the first row of sub-pixels is the previous row of sub-pixels and the second row of sub-pixels is the target row of sub-pixels. The first small cell (1, 1)-G35 represents that the sub-pixel at the first row and first column has Gray (grayscale) 35, that is, the display of this sub-pixel in the target frame is grayscale 35. The rightmost small cell of each row represents the maximum value (Max) and minimum value (Min) of grayscales of all sub-pixels in this row. After data analysis of this frame is completed, a table of corresponding grayscales can be obtained, and the processor makes analysis through an algorithm. When the processor determines that grayscales of sub-pixels in the first row of sub-pixels are the same as that of corresponding sub-pixels in the second row of sub-pixels, the first algorithm is implemented in this case. That is, the first row of sub-pixels and the second row of sub-pixels are simultaneously charged and charged to the same grayscales, which saves the charging time of one row and also saves the scan time of one row.

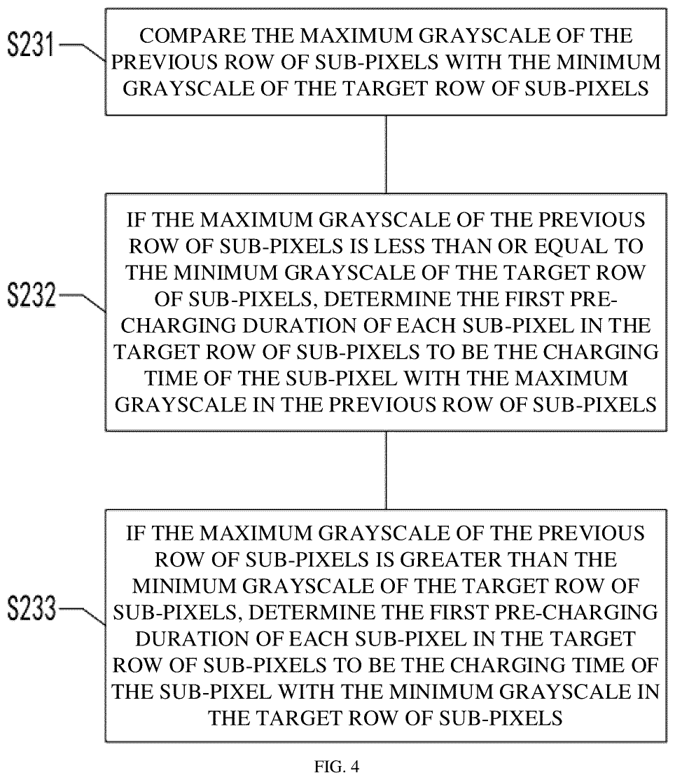

Referring to FIG. 4, S230 includes detailed steps: S231, S232, and S233.

S231, the maximum grayscale of the previous row of sub-pixels is compared with the minimum grayscale of the target row of sub-pixels. The maximum grayscale of the previous row of sub-pixels and the minimum grayscale of the target row of sub-pixels are determined by the processor through an algorithm.

S232, if the maximum grayscale of the previous row of sub-pixels is less than or equal to the minimum grayscale of the target row of sub-pixels, the first pre-charging duration of each sub-pixel in the target row of sub-pixels is determined to be the charging time of the sub-pixel with the maximum grayscale in the previous row of sub-pixels.

S233, if the maximum grayscale of the previous row of sub-pixels is greater than the minimum grayscale of the target row of sub-pixels, the first pre-charging duration of each sub-pixel in the target row of sub-pixels is determined to be the charging time of the sub-pixel with the minimum grayscale in the target row of sub-pixels.

S232 is the second case for two adjacent rows of sub-pixels in embodiments of the present application, as shown in Table 2.

TABLE 2

| | | | | |
|---|---|---|---|---|
| (1, 1)-G35 | (1, 2)-G42 | . . . | (1, n)-G48 | Max (1, 1~n)-G48 |
| | | | | Min (1, 1~n)-G23 |
| (2, 1)-G120 | (2, 2)-G100 | . . . | (2, n)-G180 | Max (2, 1~n)-G230 |
| | | | | Min (2, 1~n)-G100 |
| (3, 1)-G120 | (3, 2)-G160 | . . . | (3, n)-G68 | Max (3, 1~n)-G160 |
| | | | | Min (3, 1~n)-G68 |

In the second case for two adjacent rows of sub-pixels, the first row of sub-pixels is the previous row of sub-pixels and the second row of sub-pixels is the target row of sub-pixels. The processor makes analysis through an algorithm. When the processor determines that grayscales of at least some sub-pixels in the previous row of sub-pixels are different from grayscales of corresponding sub-pixels in the target row of sub-pixels and the maximum value of the grayscales of the sub-pixels in the previous row of sub-pixels is less than or equal to the minimum value of the grayscales of the sub-pixels in the target row of sub-pixels, the second algorithm is implemented.

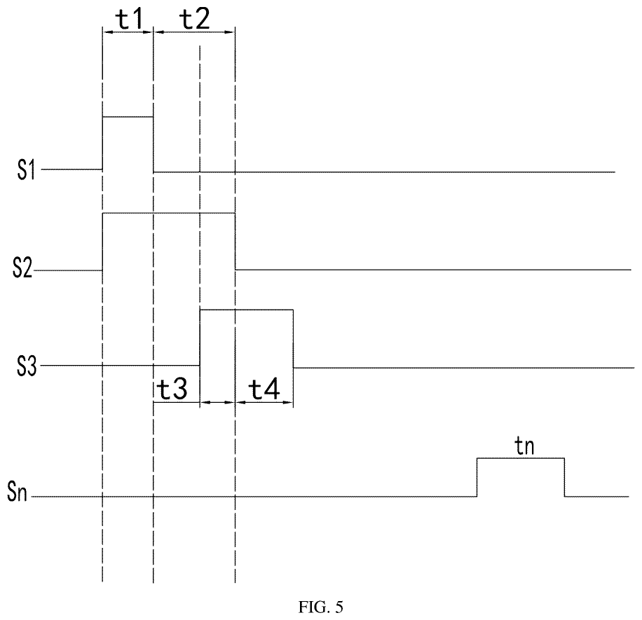

In FIGS. 5, S1 and S2 correspond to scan signals of the first row of sub-pixels and the second row of sub-pixels, respectively. Since the grayscale of each sub-pixel in the first row of sub-pixels is smaller than that of each sub-pixel in the second row of sub-pixels, the scan signal of the second row of sub-pixels is applied in advance to pre-charge the second row of sub-pixels. As can be seen, since the grayscales of the first row of sub-pixels are relatively small, t1 (the scan time of one row) can be defined as the charging time of the sub-pixel with the maximum grayscale in the first row of sub-pixels, that is, t1 corresponds to the charging time of G48. Since the grayscale is relatively small, such a long charging time is not required, and this charging time can be compressed. ΔQ=C×ΔV=I×Δt, where C is the charge amount and is a constant, and then ΔV=I×Δt/C. AV is the voltage difference across C, one end of C is the power supply voltage VDD, which is a constant, and the other end of C is the data voltage Vdata, VDD-Vdata=ΔV=I×Δt/C, and then Δt=(VDD−Vdata)×C/I, obtaining the shortest charging time required for the highest grayscale of one row of sub-pixels. Alternatively, in the early stages of design, based on the driving circuit parameters and panel conditions, the shortest charging time for each grayscale can be calculated by using software simulation and theoretical calculation, and then during display, this time can be directly invoked after actual verification.

As shown in the grayscale data of the first row of sub-pixels and the grayscale data of the second row of sub-pixels in Table 2, the maximum grayscale of the first row of sub-pixels is G48, and the minimum grayscale of the second row of sub-pixels is G100. As can be seen, the maximum grayscale of the first row of sub-pixels is smaller than the minimum grayscale of the second row of sub-pixels. In this case, as shown in FIG. 5, when the switch device corresponding to the first row of sub-pixels is turned on, the switch device corresponding to the second row of sub-pixels is turned on at the same time, for charging. Time t1 is the charging time for the maximum grayscale G48 of the first row of sub-pixels. During this time, the second row of sub-pixels are also pre-charged to the grayscale of the first row of sub-pixels, that is, the grayscales of the second row of sub-pixels are pre-charged to G48, where the grayscales of the second row of sub-pixels can also be pre-charged to any grayscale in the range of G23-G48.

After the switch device corresponding to the first row of sub-pixels is turned off, the switch device corresponding to the second row of sub-pixels continues to be turned on, to correct the grayscales of the second row of sub-pixels to the actual grayscales (which can be understood as required grayscales) of the second row of sub-pixels, which is equivalent to charging from the grayscale data of the first row of sub-pixels to the actual grayscales of the second row of sub-pixels. The charging time required to reach the actual grayscales of the second row of sub-pixels is t2, where time t2 is the time to charge from G48 to G230 (which is an example of a required grayscale). Time t1 is the first pre-charging duration of each sub-pixel in the second row of sub-pixels. The total charging time of the second row of sub-pixels is reduced from the original (t1+t2) to t2, thereby reducing the charging time and scan time.

S233 is the third case for two adjacent rows of sub-pixels in embodiments of the present application, as shown in the second row of grayscale data and the third row of grayscale data in Table 2.

In the third case for two adjacent rows of sub-pixels, in Table 2, the second row of sub-pixels is the previous row of sub-pixels, and the third row of sub-pixels is the target row of sub-pixels. The processor makes analysis through an algorithm. When the processor determines that grayscales of at least some sub-pixels in the previous row of sub-pixels are different from grayscales of corresponding sub-pixels in the target row of sub-pixels and the maximum value of the grayscales of the sub-pixels in the previous row of sub-pixels is greater than the minimum value of the grayscales of the sub-pixels in the target row of sub-pixels, the third algorithm is implemented.

Refer to FIG. 5 and Table 2. For example, for the grayscale data of the second row of sub-pixels and the grayscale data of the third row of sub-pixels in Table 2, the grayscale range of the second row of sub-pixels is G100 to G230, and the grayscale range of the third row of sub-pixels is G68 to G160, so the two rows of grayscale data are overlapping. In this case, taking the minimum grayscale G68 of the third row of sub-pixels as a reference, at the later stage while the switch device corresponding to the second row of sub-pixels is turned on, the switch device corresponding to the third row of sub-pixels is turned on, and the maximum grayscale of the sub-pixels in the third row of sub-pixels is charged to G68 (because the grayscale of each column of the previous row of sub-pixels is different, the voltage reached by the final charging result within time t2 is also different, so it is only necessary to ensure the time for charging to the maximum G68, to avoid wasting power consumption due to discharge). The minimum grayscale of the third row of sub-pixels is G68, and the maximum grayscale of the second row of sub-pixels is G230, in other words, the maximum value of the grayscales of the sub-pixels in the second row of sub-pixels is greater than the minimum value of the grayscales of the sub-pixels in the third row of sub-pixels, then the first pre-charging duration of each sub-pixel in the third row of sub-pixels is the charging time for grayscale G68. That is, time t3 is the first pre-charging duration of the third row of sub-pixels, and the algorithm of time t3 is the time for the sub-pixel with the highest grayscale in the second row of sub-pixels to charge from 0 to G68 (because the larger the voltage difference, the larger the ΔV, the faster the charging). After the pre-charging is completed, the switch device corresponding to the second row of sub-pixels is turned off, and the switch device corresponding to the third row of sub-pixels is turned on to charge to the actual grayscales of the third row of sub-pixels. The charging time required to reach the actual grayscales of the third row of sub-pixels is t4, where time t4 is the time to charge from G68 to G160, that is, time t3 is the first pre-charging duration of each sub-pixel in the third row of sub-pixels. The total charging time of the third row of sub-pixels is reduced from the original (t3+t4) to t4, thereby reducing the charging time and scan time.

In the driving method for the display panel provided in embodiments of the present application, according to the actual display situation, three algorithms are used for two adjacent rows of sub-pixels, thereby reducing the scan time and the data time and improving the efficiency of data transmission. In this way, a high-speed machine can be designed with a lower-speed driving circuit, and the circuit does not need to be modified, but only the period of the scan signal and the format of the data signal need to be modified, which is easy to implement. Meanwhile, the time for transmission of one frame can also be reduced, and the display of multiple frames can be increased, thereby improving product quality. This method is also applicable to display structures with row-by-row scan, such as LCD and OLED. With this method, the product performance can be effectively improved, and compression of both the scan time and data time can be easily achieved through the algorithm, thereby improving product performance and quality.

In embodiments of the present application, a preset correspondence is stored in the driving circuit, and the preset correspondence includes a one-to-one correspondence between multiple grayscales and multiple data voltages Vdata. Exemplarily, the preset correspondence includes a one-to-one correspondence between grayscale 0 to grayscale 255 and 256 data voltages Vdata.

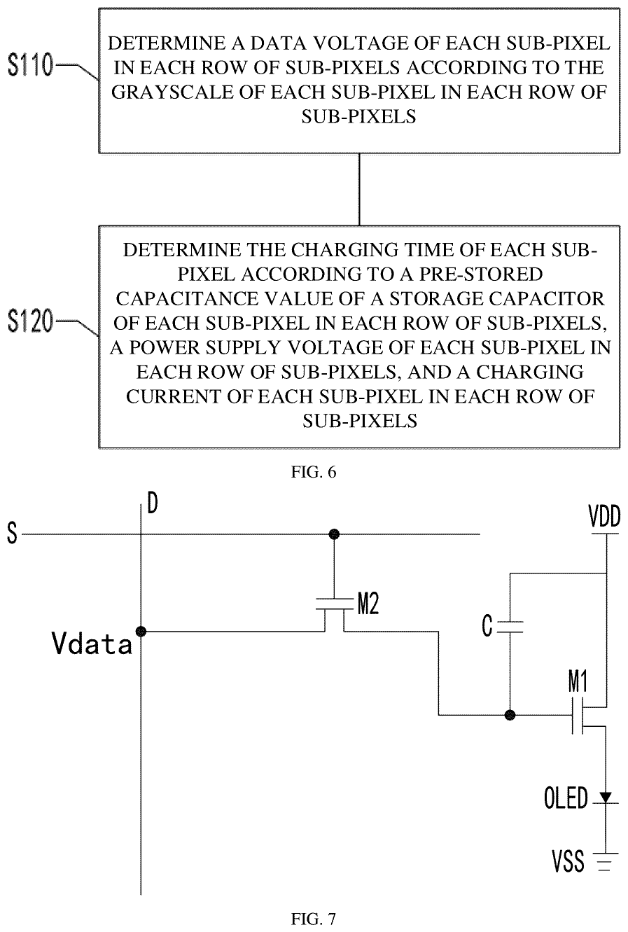

Referring to FIG. 6, S100 includes detailed steps: S110 and S120.

S110, a data voltage of each sub-pixel in each row of sub-pixels is determined according to the grayscale of each sub-pixel in each row of sub-pixels. The data voltage is a key parameter for controlling the brightness of the sub-pixel, and different data voltage values will cause the sub-pixels to display different brightness, thereby forming different grayscales.

S120, the charging time of each sub-pixel is determined according to a pre-stored capacitance value of a storage capacitor of each sub-pixel in each row of sub-pixels, a power supply voltage of each sub-pixel in each row of sub-pixels, and a charging current of each sub-pixel in each row of sub-pixels.

For example, in some embodiments, each sub-pixel has a 2T1C structure as shown in FIG. 7, that is, the sub-pixel includes a driving transistor M1, a scan transistor M2, a storage capacitor C, and a light-emitting element. The first end of the storage capacitor C is configured to receive the power supply voltage VDD, and the second end of the storage capacitor C is configured to receive the data voltage Vdata of the sub-pixel when the scan line S scans the sub-pixel. In other embodiments, each sub-pixel may also have other circuit structures, such as 4T1C, 5T1C, 6T1C, 7T2C, etc., which is not limited herein.

The light-emitting element may be an OLED or an LCD. In the OLED, the cathode of the OLED is configured to receive a reference voltage VSS. The source of the driving transistor M1 is configured to receive a power supply voltage VDD, the drain of the driving transistor M1 is electrically connected to the anode of the light-emitting element, the gate of the driving transistor M1 is electrically connected to the drain of the scan transistor M2. The source of the scan transistor M2 is electrically connected to the data line D and is configured to receive a data voltage Vdata through the data line D, and the gate of the scan transistor M2 is electrically connected to the scan line S and is configured to receive a scan signal through the scan line S. The first end of the storage capacitor C is electrically connected to the source of the driving transistor M1, and the second end of the storage capacitor C is electrically connected to the gate of the driving transistor M1. Exemplarily, when the scan line S corresponding to the sub-pixel scans the present row of sub-pixels, that is, when the scan signal is received, the scan transistor M2 is turned on, and the data voltage Vdata on the data line D charges the storage capacitor C through the scan transistor M2, to charge the voltage at the second end of the storage capacitor C to the data voltage Vdata, and the driving transistor M1 drives the light-emitting element to emit light based on the data voltage Vdata received by its gate and the power supply voltage VDD received by its source. In this case, the source-gate voltage Vsg of the driving transistor M1 is Vsg=VDD-Vdata, and the driving current Ids flowing through the light-emitting element and the source-gate voltage Vsg of the driving transistor M1 have the following relationship:

$${I}_{ds} = ( 1 / 2 ) \times ( W / L ) \times μ \times {C}_{ox} \times {( V DD - V data - \vert {V}_{t h} \vert )}^{2}$$

where VDD is the power supply voltage, W and L are the width and length of the transistor channel respectively, μ is the effective carrier mobility, Cₒₓ is the capacitance per unit area of the gate oxide layer, Vdata is the input data voltage, and Vₜₕ is the threshold voltage of the driving transistor M1.

The charging time of each sub-pixel is determined according to the pre-stored capacitance value of the storage capacitor C of each sub-pixel in each row of sub-pixels, the power supply voltage of each sub-pixel in each row of sub-pixels, and the charging current of each sub-pixel in each row of sub-pixels, by using the following formula:

$$t = ( V DD - V data ) \times C / I$$

where t is the charging time of each sub-pixel, VDD is the power supply voltage of each sub-pixel in each row of sub-pixels, Vdata is the data voltage of each sub-pixel, C is the capacitance value of the storage capacitor of each sub-pixel in each row of sub-pixels, and I is the charging current of each sub-pixel in each row of sub-pixels.

In an implementation, the charging current provided by the driving circuit may be obtained by testing the display device before the display device leaves the factory and stored in the driving circuit.

In the driving method for the display panel provided in the present application, before determining the charging time of each sub-pixel according to the preset charging formula based on the data voltage Vdata of each sub-pixel, the driving method also includes: establishing a simulation model of the display panel, and obtaining the capacitance value of the storage capacitor C by simulating and analyzing the simulation model.

Since the circuit structure of each sub-pixel is the same, the capacitance value of the storage capacitor C in each sub-pixel is almost equal. In other embodiments, the capacitance value of the storage capacitor C can also be determined by other methods, for example, by performing a charging test on the display panel.

It should be noted that, since the storage capacitor C is an energy storage element, the charging current provided by the driving circuit to the storage capacitor C is not determined by the capacitance value of the storage capacitor C, but by the driving capability of the driving circuit itself. In other words, when the driving circuit provides different data voltages Vdata, the charging current output to each sub-pixel can reach the maximum charging current. Therefore, the shortest charging time of each sub-pixel can be obtained based on the maximum charging current.

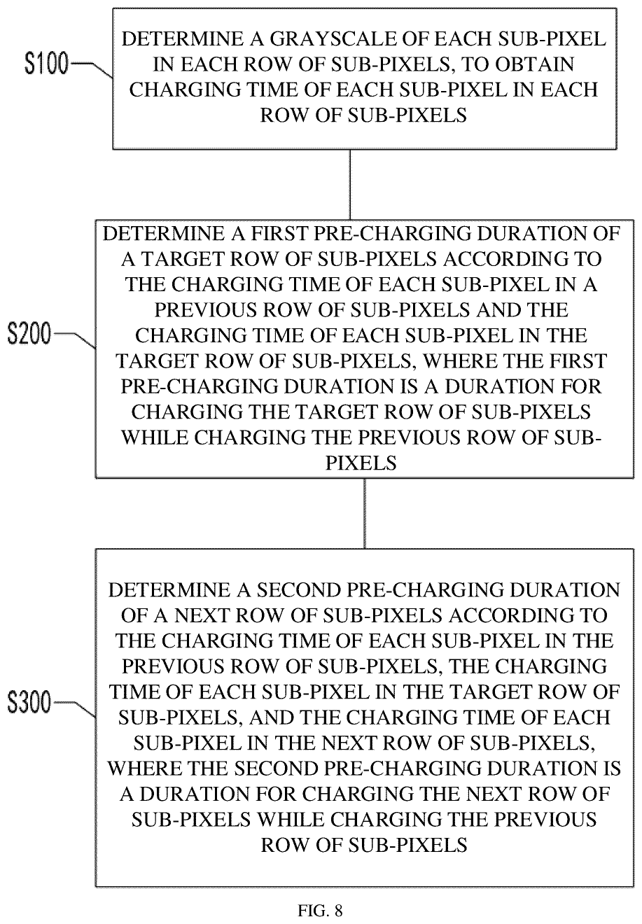

Referring to FIG. 8, the driving method for the display panel provided in the present application further includes the following.

S300, a second pre-charging duration of a next row of sub-pixels is determined according to the charging time of each sub-pixel in the previous row of sub-pixels, the charging time of each sub-pixel in the target row of sub-pixels, and the charging time of each sub-pixel in the next row of sub-pixels, where the second pre-charging duration is a duration for charging the next row of sub-pixels while charging the previous row of sub-pixels.

The second pre-charging duration is a duration in which the previous row of sub-pixels and the next row of sub-pixels are charged simultaneously.

Through S100 to S300, in three adjacent rows of sub-pixels, the target row of sub-pixels and the next row of sub-pixels can be pre-charged while the previous row of sub-pixels is charged, to reduce the scan time of the target row of sub-pixels and the next row of sub-pixels, thereby further improving the overall data transmission rate of the display panel.

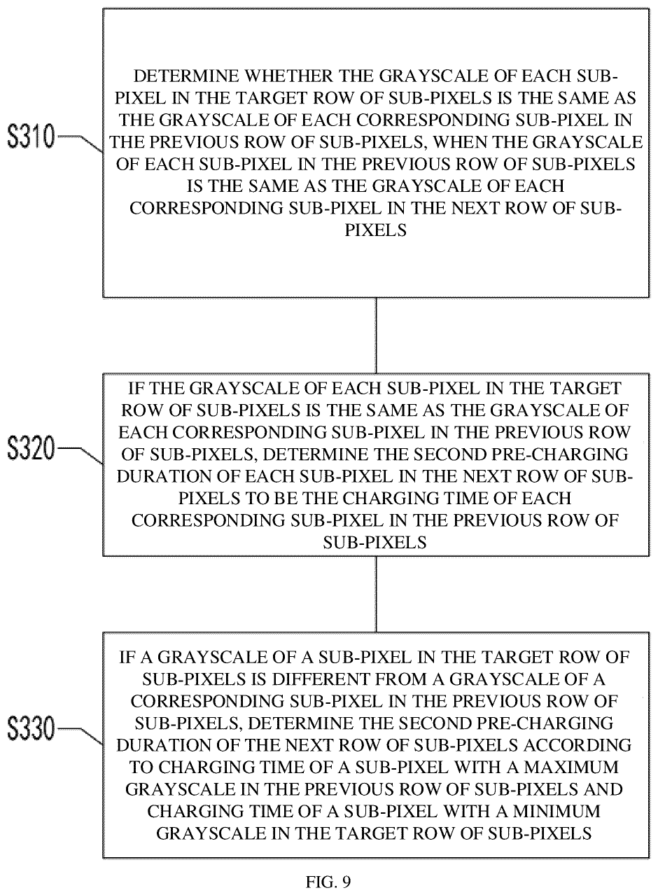

Referring to FIG. 9, S300 includes detailed steps: S310, S320, and S330.

S310, whether the grayscale of each sub-pixel in the target row of sub-pixels is the same as the grayscale of each corresponding sub-pixel in the previous row of sub-pixels is determined, when the grayscale of each sub-pixel in the previous row of sub-pixels is the same as the grayscale of each corresponding sub-pixel in the next row of sub-pixels.

S320, if the grayscale of each sub-pixel in the target row of sub-pixels is the same as the grayscale of each corresponding sub-pixel in the previous row of sub-pixels, the second pre-charging duration of each sub-pixel in the next row of sub-pixels is determined to be the charging time of each corresponding sub-pixel in the previous row of sub-pixels.

S330, if a grayscale of a sub-pixel in the target row of sub-pixels is different from a grayscale of a corresponding sub-pixel in the previous row of sub-pixels, the second pre-charging duration of the next row of sub-pixels is determined according to charging time of a sub-pixel with a maximum grayscale in the previous row of sub-pixels and charging time of a sub-pixel with a minimum grayscale in the target row of sub-pixels.

In other word, if not all grayscales of the sub-pixels in the target row of sub-pixels are the same as all grayscales of corresponding sub-pixels in the previous row of sub-pixels, the determining in S330 is performed.

Specifically, each sub-pixel in the previous row of sub-pixels, each sub-pixel in the target row of sub-pixels, and each sub-pixel in the next row of sub-pixels are in one-to-one correspondence. That is, in the previous row of sub-pixels, the target row of sub-pixels, and the next row of sub-pixels, the sub-pixel at the first column in the previous row of sub-pixels, the sub-pixel at the first column in the target row of sub-pixels, and the sub-pixel at the first column in the next row of sub-pixels are in one-to-one correspondence, the sub-pixel at the second column in the previous row of sub-pixels, the sub-pixel at the second column in the target row of sub-pixels, and the sub-pixel at the second column in the next row of sub-pixels are in one-to-one correspondence, the sub-pixel at the third column in the previous row of sub-pixels, the sub-pixel at the third column in the target row of sub-pixels, and the sub-pixel at the third column in the next row of sub-pixels are in one-to-one correspondence, and so on.

S320 is the first case for three adjacent rows of sub-pixels in embodiments of the present application, as shown in Table 3

TABLE 3

| | | | | |
|---|---|---|---|---|
| (1, 1)-G35 | (1, 2)-G42 | . . . | (1, n)-G48 | Max (1, 1~n)-G48 |
| | | | | Min (1, 1~n)-G23 |
| (2, 1)-G35 | (2, 2)-G42 | . . . | (2, n)-G48 | Max (2, 1~n)-G48 |
| | | | | Min (2, 1~n)-G23 |
| (3, 1)-G35 | (3, 2)-G42 | . . . | (3, n)-G48 | Max (3, 1~n)-G48 |
| | | | | Min (3, 1~n)-G23 |

In the first case for three adjacent rows of sub-pixels, the first row of sub-pixels is the previous row of sub-pixels, the second row of sub-pixels is the target row of sub-pixels, and the third row of sub-pixels is the next row of sub-pixels. The processor makes analysis through an algorithm. When the processor determines that the grayscale of each sub-pixel in the first row of sub-pixels and the grayscale of each corresponding sub-pixel in the third row of sub-pixels are the same, whether the grayscale of each sub-pixel in the first row of sub-pixels and the grayscale of each corresponding sub-pixel in the second row of sub-pixels are the same is further determined. When the processor determines that the grayscale of each sub-pixel in the first row of sub-pixels, the grayscale of each corresponding sub-pixel in the second row of sub-pixels, and the grayscale of each corresponding sub-pixel in the third row of sub-pixels are the same, the first row of sub-pixels, the second row of sub-pixels, and the third row of sub-pixels are charged at the same time and charged to the same grayscales, saving the charging time of two rows, and also saving the scan time of two rows.

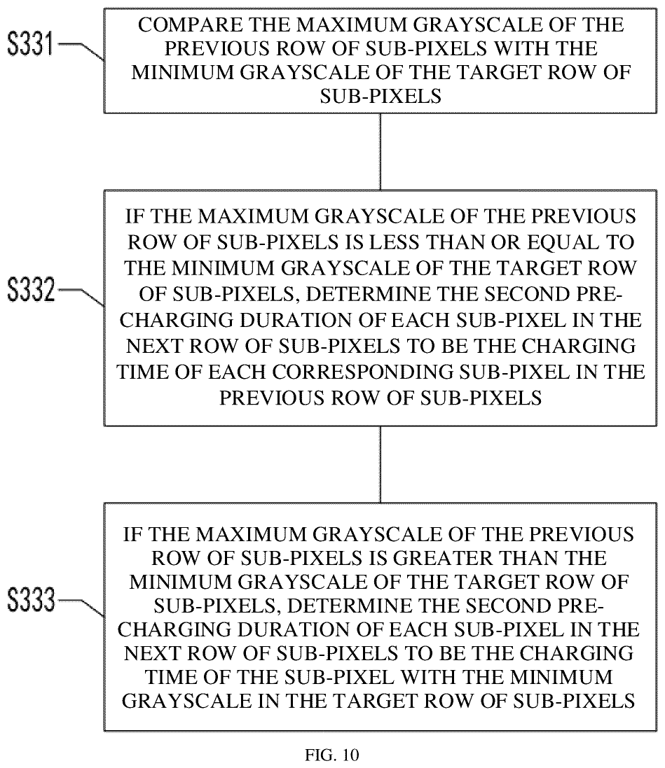

If the grayscale of each sub-pixel in the target row of sub-pixels is different from the grayscale of each corresponding sub-pixel in the previous row of sub-pixels, the second pre-charging duration of the next row of sub-pixels is determined according to the charging time of the sub-pixel with the maximum grayscale in the previous row of sub-pixels and the charging time of the sub-pixel with the minimum grayscale in the target row of sub-pixels. For details, referring to FIG. 10, S330 includes detailed steps: steps S331, S332, and S333.

S331, the maximum grayscale of the previous row of sub-pixels is compared with the minimum grayscale of the target row of sub-pixels.

S332, if the maximum grayscale of the previous row of sub-pixels is less than or equal to the minimum grayscale of the target row of sub-pixels, the second pre-charging duration of each sub-pixel in the next row of sub-pixels is determined to be the charging time of each corresponding sub-pixel in the previous row of sub-pixels.

S333, if the maximum grayscale of the previous row of sub-pixels is greater than the minimum grayscale of the target row of sub-pixels, the second pre-charging duration of each sub-pixel in the next row of sub-pixels is determined to be the charging time of the sub-pixel with the minimum grayscale in the target row of sub-pixels.

S332 is the second case for three adjacent rows of sub-pixels in embodiments of the present application, as shown in Table 4.

TABLE 4

| | | | | |
|---|---|---|---|---|
| (1, 1)-G35 | (1, 2)-G42 | . . . | (1, n)-G48 | Max (1, 1~n)-G48 |
| | | | | Min (1.1~n)-G23 |
| (2, 1)-G120 | (2, 2)-G100 | . . . | (2, n)-G180 | Max (2, 1~n)-G230 |
| | | | | Min (2, 1~n)-G100 |
| (3, 1)-G35 | (3, 2)-G42 | . . . | (3, n)-G48 | Max (3, 1~n)-G48 |
| | | | | Min (3, 1~n)-G23 |

In the second case for three adjacent rows of sub-pixels, the first row of sub-pixels is the previous row of sub-pixels, the second row of sub-pixels is the target row of sub-pixels, and the third row of sub-pixels is the next row of sub-pixels. The processor makes analysis through an algorithm. When the processor determines that the grayscales of at least some sub-pixels in the previous row of sub-pixels are different from the grayscales of corresponding sub-pixels in the target row of sub-pixels and the maximum value of the grayscales of the sub-pixels in the previous row of sub-pixels is less than or equal to the minimum value of the grayscales of the sub-pixels in the target row of sub-pixels, the second pre-charging duration of each sub-pixel in the next row of sub-pixels is the charging time of each corresponding sub-pixel in the previous row of sub-pixels.

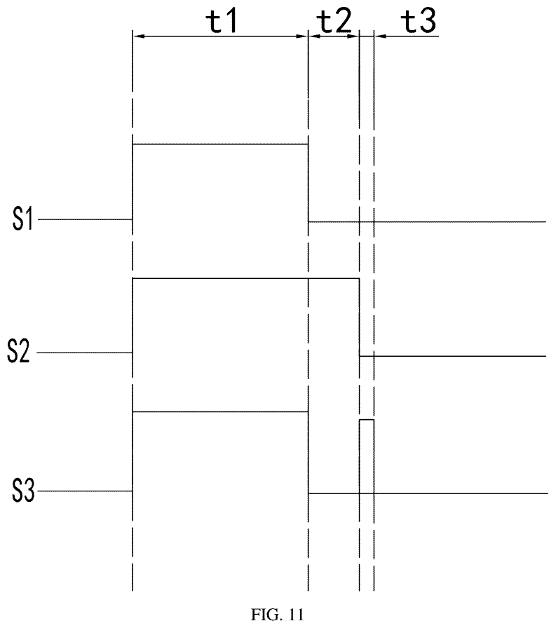

In FIGS. 11, S1, S2 and S3 correspond to the scan signals of the first row of sub-pixels, the second row of sub-pixels and the third row of sub-pixels, respectively. Since the grayscale of each sub-pixel in the first row of sub-pixels and the grayscale of each sub-pixel in the third row of sub-pixels are both smaller than the grayscale of each sub-pixel in the second row of sub-pixels, the scan signals of the first row of sub-pixels, the second row of sub-pixels, and the third row of sub-pixels can be simultaneously turned on, and the second row of sub-pixels and the third row of sub-pixels can be pre-charged. As can be seen, since the grayscales of both the first row of sub-pixels and the third row of sub-pixels are small, t1 can be defined as the charging time of the sub-pixel with the maximum grayscale in the first row of sub-pixels, that is, t1 is the charging time corresponding to G48.

As shown in the grayscale data of the first row of sub-pixels, the grayscale data of the second row of sub-pixels, and the grayscale data of the third row of sub-pixels in Table 4, the maximum grayscale of the first row of sub-pixels is G48, the minimum grayscale of the second row of sub-pixels is G100, and the maximum grayscale of the third row of sub-pixels is G48. As can be seen, both the maximum grayscale of the first row of sub-pixels and the maximum grayscale of the third row of sub-pixels are smaller than the minimum grayscale of the second row of sub-pixels. In this case, as shown in FIG. 11, when the switch device corresponding to the first row of sub-pixels is turned on, the switch device corresponding to the second row of sub-pixels and the switch device corresponding to the third row of sub-pixels are turned on at the same time, for charging. Time t1 is the charging time for the maximum grayscale G48 of the first row of sub-pixels. During this time, the second row of sub-pixels are also pre-charged to the grayscale of the first row of sub-pixels, that is, the grayscale of each sub-pixel in the second row of sub-pixels is pre-charged to G48, and the grayscales of the third row of sub-pixels are pre-charged to the actual grayscales of the third row of sub-pixels. The grayscale of each sub-pixel in the second row of sub-pixels can also be pre-charged to any grayscale in the range of G23-G48.

After the switch device corresponding to the first row of sub-pixels and the switch device corresponding to the third row of sub-pixels are turned off, the switch device corresponding to the second row of sub-pixels continues to be turned on, to correct the grayscales of the second row of sub-pixels to the actual grayscales of the second row of sub-pixels, which is equivalent to charging from the grayscale data of the first row of sub-pixels to the actual grayscales of the second row of sub-pixels. The charging time required to reach the actual grayscales of the second row of sub-pixels is t2, where time t2 is the time to charge from G48 to G230. Time t1 is the second pre-charging duration of each sub-pixel in the third row of sub-pixels. During the second pre-charging duration, the third row of sub-pixels are charged to the actual grayscales, and the second row of sub-pixels can be pre-charged within the second pre-charging duration. The total charging time of the second row of sub-pixels is reduced from the original (t1+t2) to t2, further reducing the charging time and scan time.

After charging of the second row of sub-pixels is completed, the switch device corresponding to the second row of sub-pixels is turned off, and the switch device corresponding to the third row of sub-pixels is turned on to charge the third row of sub-pixels for t3, where t3 is a very short period of time. t3 is configured to correct the grayscale data of the third row of sub-pixels to prevent leakage and incorrect charging. Time t3 can be about 0.1 μs.

S333 is the third case for three adjacent rows of sub-pixels in embodiments of the present application, as shown in Table 5.

TABLE 5

| | | | | |
|---|---|---|---|---|
| (1, 1)-G120 | (1, 2)-G100 | . . . | (1, n)-G180 | Max (1, 1~n)-G230 |
| | | | | Min (1.1~n)-G100 |
| (2, 1)-G120 | (2, 2)-G160 | . . . | (2, n)-G68 | Max (2, 1~n)-G160 |
| | | | | Min (2, 1~n)-G68 |
| (3, 1)-G120 | (3, 2)-G100 | . . . | (3, n)-G180 | Max (3, 1~n)-G230 |
| | | | | Min (3, 1~n)-G100 |

In the third case for three adjacent rows of sub-pixels, in Table 5, the first row of sub-pixels is the previous row of sub-pixels, the second row of sub-pixels is the target row of sub-pixels, and the third row of sub-pixels is the next row of sub-pixels. The processor makes analysis through an algorithm. When the processor determines that the grayscales of at least some sub-pixels in the previous row of sub-pixels are different from the grayscales of corresponding sub-pixels in the target row of sub-pixels and the maximum value of the grayscales of the sub-pixels in the previous row of sub-pixels is greater than the minimum value of the grayscales of the sub-pixels in the target row of sub-pixels, the second pre-charging duration of each sub-pixel in the next row of sub-pixels is the charging time of the sub-pixel with the minimum grayscale in the target row of sub-pixels.

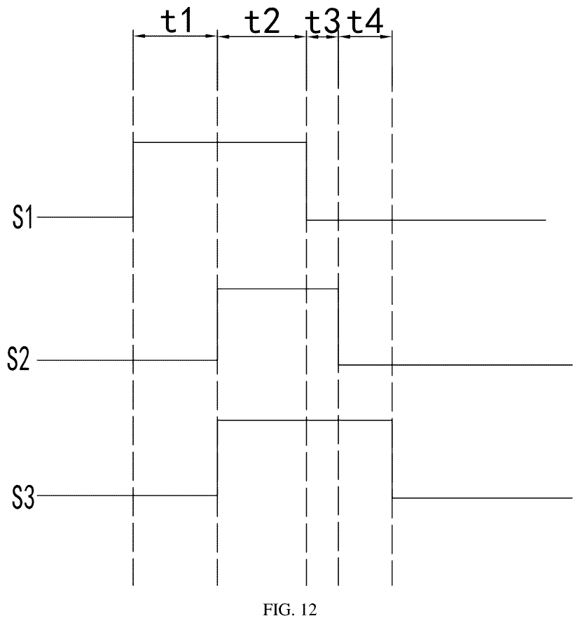

Referring to FIG. 12 and Table 5. The grayscale ranges of the first row of sub-pixels and the second row of sub-pixels are both G100 to G230, and the grayscale range of the second row of sub-pixels is G68 to G160, so the grayscale data of the second row of sub-pixels and the grayscale data of the third row of sub-pixels are overlapping. S1, S2, and S3 correspond to the scan signals of the first row of sub-pixels, the second row of sub-pixels, and the third row of sub-pixels, respectively.

The switch device corresponding to S1 (because it is not possible directly turn on S3 without turning on S2) is turned on and charged for t1, and then the switch devices corresponding to the three rows of S1, S2 and S3 are turned on at the same time. The grayscale data of S1 and S3 are provided during t1 and t2, and the charging of S1 is completed at the end of t2. During t2, the switch device corresponding to S2 and the switch device corresponding to S3 are turned on. In this case, the grayscales of the sub-pixels in the third row of sub-pixels are charged to G68, and the grayscale data of the second row of sub-pixels and the third row of sub-pixels have not reached the actual grayscales. t2 is the second pre-charging duration and t2 is the charging time of the sub-pixel with the minimum grayscale in the second row of sub-pixels, which reduces the charging time and scan time. The scan line of S1 is turned off, and for the data of S2 and S3, the grayscale data of S2 is provided during t3. After charging to the data of S2, S2 is turned off, and for S3, the grayscale data of S3 continues to be charged until it is fully charged. Time (t1+t2) is the maximum charging time for scanning of the first row, and time t2 is the time for the second row to charge to the grayscale data close to S2 (the capacitor charging may have a certain deviation) under the grayscale data of S1. The calculation formula for capacitor charging and discharging time is: Vₜ=V₀+(Vᵤ−V₀)×[1−exp (−t/RC)]. Vois the initial voltage value on the capacitor; Vᵤ is the termination voltage when the capacitor is fully charged; Vₜ is the voltage value on the capacitor at any time t. Time t4 is the time for the third row of sub-pixels to charge from G160 to G230.

Based on the same inventive concept, embodiments of the present application further provide a driving circuit. The driving circuit is configured to control the steps of the driving method for the display panel of any of the above embodiments to drive the display panel for display.

In some embodiments, the driving circuit includes a scan-driving circuit, a data-driving circuit, and a timing controller (TCON). The scan-driving circuit is electrically connected to each row of sub-pixels through n scan lines S, and the scan-driving circuit is configured to generate a corresponding scan signal for each row of sub-pixels. The data-driving circuit is electrically connected to each column of sub-pixels through m data lines D, and the data-driving circuit is configured to: generate a corresponding data voltage Vdata for each column of sub-pixels and output the data voltage Vdata to each sub-pixel in the column of sub-pixels.

The timing controller is configured to: obtain image data of a picture to be displayed, and determine a necessary charging duration of each row of sub-pixels according to the image data, allocate a corresponding scan time to each scan line S according to the necessary charging duration of each row of sub-pixels, and control the scan-driving circuit to control n scan lines S to scan n rows of sub-pixels sequentially in a preset order, to drive the display panel to display the picture to be displayed.

In some embodiments, the timing controller is further configured to: determine a grayscale of each sub-pixel according to the image data, determine the sub-pixel with the highest grayscale in each row of sub-pixels as the sub-pixel of the row of sub-pixels, determine the shortest charging duration of each sub-pixel according to the grayscale of each sub-pixel, and determine the shortest charging duration of each sub-pixel as the necessary charging duration of the row of sub-pixels where the sub-pixel is located.

In some embodiments, a preset correspondence is stored in the driving circuit and the preset correspondence includes a one-to-one correspondence between multiple grayscales and multiple data voltages Vdata. The timing controller is further configured to: determine the data voltage Vdata of each sub-pixel according to the grayscale of each sub-pixel and the preset correspondence, and determine the shortest charging duration of each sub-pixel according to the data voltage Vdata of each sub-pixel.

In some embodiments, the timing controller is further configured to determine the charging time of each sub-pixel according to a preset charging formula based on the data voltage Vdata of each sub-pixel.

In some embodiments, the timing controller is further configured to: determine the highest data voltage Vdata corresponding to the highest grayscale from the preset correspondence, and determine the maximum charging current provided by the driving circuit according to the highest data voltage Vdata and the shortest scan time of the driving circuit. The shortest scan time is the scan time of one scan line S of the driving circuit in the highest refresh rate mode.

Based on the same inventive concept, embodiments of the present invention further provide a storage medium. The storage medium stores computer instructions. When the computer instructions are executed on a computer, the computer executes each process of the above-mentioned driving method embodiments and can achieve the same technical effect. To avoid repetition, it is not repeated herein. For example, the storage medium can be a read-only memory (ROM), a random access memory (RAM), a disk or an optical disk, etc.

Based on the same inventive concept, embodiments of the present application also provide a display device. The display device includes a driving circuit of any of the above embodiments, and a display panel. The driving circuit is electrically connected to the display panel and is configured to drive the display panel to display. The display device includes a display panel and a driving circuit, and the display panel includes a display area and a non-display area. The display panel includes n scan lines S extending in a row direction and arranged in a column direction, m data lines D extending in the column direction and arranged in the row direction, and multiple sub-pixels defined by intersections of the n scan lines S and the m data lines D, where n is greater than 1 and m is greater than 1, for example, n=1080, m=3×1920.

The driving circuit and the display device correspond to the aforementioned driving method for the display panel. For a more detailed description, reference can be made to the contents of the various embodiments of the aforementioned driving method for the display panel.

In the description of the embodiments of the present application, it should be noted that the orientation or positional relationship of terms such as “center”, “up”, “down”, “left”, “right”, “vertical”, “horizontal”, “inside”, and “outside” are based on the orientation or positional relationship described in the accompanying drawings. These are merely for the convenience of describing the present application and simplifying the description, and do not indicate or imply that the referred device or element must have a specific orientation, be constructed and operated in a specific orientation, and therefore cannot be understood as a limitation on the present application.

The above is merely a preferred embodiment of the present application but not used to limit the scope of rights of the present application. Ordinary skilled in the art can understand that all or part of the processes for implementing the above embodiments and equivalent changes made according to the claims of the present application are still within the scope covered by the present application.

What is claimed is:

1. A driving method for a display panel, applicable to the display panel comprising a plurality of rows of sub-pixels and the driving method comprising:
determining a grayscale of each sub-pixel in each row of sub-pixels, to obtain charging time of each sub-pixel in each row of sub-pixels; and
determining a first pre-charging duration of a target row of sub-pixels according to the charging time of each sub-pixel in a previous row of sub-pixels and the charging time of each sub-pixel in the target row of sub-pixels, wherein the first pre-charging duration is a duration for charging the target row of sub-pixels while charging the previous row of sub-pixels.

2. The driving method of claim 1, wherein each sub-pixel in the previous row of sub-pixels is in one-to-one correspondence with each sub-pixel in the target row of sub-pixels, and determining the first pre-charging duration of the target row of sub-pixels according to the charging time of each sub-pixel in the previous row of sub-pixels and the charging time of each sub-pixel in the target row of sub-pixels comprises:
determining whether the grayscale of each sub-pixel in the previous row of sub-pixels is the same as the grayscale of each corresponding sub-pixel in the target row of sub-pixels;
determining the first pre-charging duration of each sub-pixel in the target row of sub-pixels to be the charging time of each corresponding sub-pixel in the previous row of sub-pixels, when the grayscale of each sub-pixel in the previous row of sub-pixels is the same as the grayscale of each corresponding sub-pixel in the target row of sub-pixels; and
determining the first pre-charging duration of the target row of sub-pixels according to charging time of a sub-pixel with a maximum grayscale in the previous row of sub-pixels and charging time of a sub-pixel with a minimum grayscale in the target row of sub-pixels, when a grayscale of a sub-pixel in the previous row of sub-pixels is different from a grayscale of a corresponding sub-pixel in the target row of sub-pixels.

3. The driving method of claim 2, wherein determining the first pre-charging duration of the target row of sub-pixels according to the charging time of the sub-pixel with the maximum grayscale in the previous row of sub-pixels and the charging time of the sub-pixel with the minimum grayscale in the target row of sub-pixels comprises:
comparing the maximum grayscale of the previous row of sub-pixels with the minimum grayscale of the target row of sub-pixels;
determining the first pre-charging duration of each sub-pixel in the target row of sub-pixels to be the charging time of the sub-pixel with the maximum grayscale in the previous row of sub-pixels, when the maximum grayscale of the previous row of sub-pixels is less than or equal to the minimum grayscale of the target row of sub-pixels; and
determining the first pre-charging duration of each sub-pixel in the target row of sub-pixels to be the charging time of the sub-pixel with the minimum grayscale in the target row of sub-pixels, when the maximum grayscale of the previous row of sub-pixels is greater than the minimum grayscale of the target row of sub-pixels.

4. The driving method of claim 1, further comprising:
determining a second pre-charging duration of a next row of sub-pixels according to the charging time of each sub-pixel in the previous row of sub-pixels, the charging time of each sub-pixel in the target row of sub-pixels, and the charging time of each sub-pixel in the next row of sub-pixels, wherein the second pre-charging duration is a duration for charging the next row of sub-pixels while charging the previous row of sub-pixels.

5. The driving method of claim 4, wherein each sub-pixel in the previous row of sub-pixels, each sub-pixel in the target row of sub-pixels, and each sub-pixel in the next row of sub-pixels are in one-to-one correspondence, and determining the second pre-charging duration of the next row of sub-pixels according to the charging time of each sub-pixel in the previous row of sub-pixels, the charging time of each sub-pixel in the target row of sub-pixels, and the charging time of each sub-pixel in the next row of sub-pixels comprises:
determining whether the grayscale of each sub-pixel in the target row of sub-pixels is the same as the grayscale of each corresponding sub-pixel in the previous row of sub-pixels, when the grayscale of each sub-pixel in the previous row of sub-pixels is the same as the grayscale of each corresponding sub-pixel in the next row of sub-pixels;
determining the second pre-charging duration of each sub-pixel in the next row of sub-pixels to be the charging time of each corresponding sub-pixel in the previous row of sub-pixels, when the grayscale of each sub-pixel in the target row of sub-pixels is the same as the grayscale of each corresponding sub-pixel in the previous row of sub-pixels; and
determining the second pre-charging duration of the next row of sub-pixels according to charging time of a sub-pixel with a maximum grayscale in the previous row of sub-pixels and charging time of a sub-pixel with a minimum grayscale in the target row of sub-pixels, when a grayscale of a sub-pixel in the target row of sub-pixels is different from a grayscale of a corresponding sub-pixel in the previous row of sub-pixels.

6. The driving method of claim 5, wherein determining the second pre-charging duration of the next row of sub-pixels according to the charging time of the sub-pixel with the maximum grayscale in the previous row of sub-pixels and the charging time of the sub-pixel with the minimum grayscale in the target row of sub-pixels comprises:
comparing the maximum grayscale of the previous row of sub-pixels with the minimum grayscale of the target row of sub-pixels;
determining the second pre-charging duration of each sub-pixel in the next row of sub-pixels to be the charging time of each corresponding sub-pixel in the previous row of sub-pixels, when the maximum grayscale of the previous row of sub-pixels is less than or equal to the minimum grayscale of the target row of sub-pixels; and
determining the second pre-charging duration of each sub-pixel in the next row of sub-pixels to be the charging time of the sub-pixel with the minimum grayscale in the target row of sub-pixels, when the maximum grayscale of the previous row of sub-pixels is greater than the minimum grayscale of the target row of sub-pixels.

7. The driving method of claim 1, wherein determining the grayscale of each sub-pixel in each row of sub-pixels, to obtain the charging time of each sub-pixel in each row of sub-pixels comprises:
determining a data voltage of each sub-pixel in each row of sub-pixels according to the grayscale of each sub-pixel in each row of sub-pixels; and
determining the charging time of each sub-pixel according to a pre-stored capacitance value of a storage capacitor of each sub-pixel in each row of sub-pixels, a power supply voltage of each sub-pixel in each row of sub-pixels, and a charging current of each sub-pixel in each row of sub-pixels.

8. The driving method of claim 7, wherein the charging time of each sub-pixel is determined according to the pre-stored capacitance value of the storage capacitor of each sub-pixel in each row of sub-pixels, the power supply voltage of each sub-pixel in each row of sub-pixels, and the charging current of each sub-pixel in each row of sub-pixels, by using the following formula:
$$t = ( V DD - V data ) \times C / I ,$$
where t is the charging time of each sub-pixel, VDD is the power supply voltage of each sub-pixel in each row of sub-pixels, Vdata is the data voltage of each sub-pixel, C is the capacitance value of the storage capacitor of each sub-pixel in each row of sub-pixels, and I is the charging current of each sub-pixel in each row of sub-pixels.

9. A driving circuit configured to execute steps in a driving method for a display panel, to drive the display panel comprising a plurality of rows of sub-pixels to display, the driving method comprising:
determining a grayscale of each sub-pixel in each row of sub-pixels, to obtain charging time of each sub-pixel in each row of sub-pixels; and
determining a first pre-charging duration of a target row of sub-pixels according to the charging time of each sub-pixel in a previous row of sub-pixels and the charging time of each sub-pixel in the target row of sub-pixels, wherein the first pre-charging duration is a duration for charging the target row of sub-pixels while charging the previous row of sub-pixels.

10. The driving circuit of claim 9, wherein each sub-pixel in the previous row of sub-pixels is in one-to-one correspondence with each sub-pixel in the target row of sub-pixels, and determining the first pre-charging duration of the target row of sub-pixels according to the charging time of each sub-pixel in the previous row of sub-pixels and the charging time of each sub-pixel in the target row of sub-pixels comprises:
determining whether the grayscale of each sub-pixel in the previous row of sub-pixels is the same as the grayscale of each corresponding sub-pixel in the target row of sub-pixels;
determining the first pre-charging duration of each sub-pixel in the target row of sub-pixels to be the charging time of each corresponding sub-pixel in the previous row of sub-pixels, when the grayscale of each sub-pixel in the previous row of sub-pixels is the same as the grayscale of each corresponding sub-pixel in the target row of sub-pixels; and
determining the first pre-charging duration of the target row of sub-pixels according to charging time of a sub-pixel with a maximum grayscale in the previous row of sub-pixels and charging time of a sub-pixel with a minimum grayscale in the target row of sub-pixels, when a grayscale of a sub-pixel in the previous row of sub-pixels is different from a grayscale of a corresponding sub-pixel in the target row of sub-pixels.

11. The driving circuit of claim 10, wherein determining the first pre-charging duration of the target row of sub-pixels according to the charging time of the sub-pixel with the maximum grayscale in the previous row of sub-pixels and the charging time of the sub-pixel with the minimum grayscale in the target row of sub-pixels comprises:
comparing the maximum grayscale of the previous row of sub-pixels with the minimum grayscale of the target row of sub-pixels;
determining the first pre-charging duration of each sub-pixel in the target row of sub-pixels to be the charging time of the sub-pixel with the maximum grayscale in the previous row of sub-pixels, when the maximum grayscale of the previous row of sub-pixels is less than or equal to the minimum grayscale of the target row of sub-pixels; and
determining the first pre-charging duration of each sub-pixel in the target row of sub-pixels to be the charging time of the sub-pixel with the minimum grayscale in the target row of sub-pixels, when the maximum grayscale of the previous row of sub-pixels is greater than the minimum grayscale of the target row of sub-pixels.

12. The driving circuit of claim 9, wherein the driving method further comprises:
determining a second pre-charging duration of a next row of sub-pixels according to the charging time of each sub-pixel in the previous row of sub-pixels, the charging time of each sub-pixel in the target row of sub-pixels, and the charging time of each sub-pixel in the next row of sub-pixels, wherein the second pre-charging duration is a duration for charging the next row of sub-pixels while charging the previous row of sub-pixels.

13. The driving circuit of claim 12, wherein each sub-pixel in the previous row of sub-pixels, each sub-pixel in the target row of sub-pixels, and each sub-pixel in the next row of sub-pixels are in one-to-one correspondence, and determining the second pre-charging duration of the next row of sub-pixels according to the charging time of each sub-pixel in the previous row of sub-pixels, the charging time of each sub-pixel in the target row of sub-pixels, and the charging time of each sub-pixel in the next row of sub-pixels comprises:
determining whether the grayscale of each sub-pixel in the target row of sub-pixels is the same as the grayscale of each corresponding sub-pixel in the previous row of sub-pixels, when the grayscale of each sub-pixel in the previous row of sub-pixels is the same as the grayscale of each corresponding sub-pixel in the next row of sub-pixels;
determining the second pre-charging duration of each sub-pixel in the next row of sub-pixels to be the charging time of each corresponding sub-pixel in the previous row of sub-pixels, when the grayscale of each sub-pixel in the target row of sub-pixels is the same as the grayscale of each corresponding sub-pixel in the previous row of sub-pixels; and
determining the second pre-charging duration of the next row of sub-pixels according to charging time of a sub-pixel with a maximum grayscale in the previous row of sub-pixels and charging time of a sub-pixel with a minimum grayscale in the target row of sub-pixels, when a grayscale of a sub-pixel in the target row of sub-pixels is different from a grayscale of a corresponding sub-pixel in the previous row of sub-pixels.

14. The driving circuit of claim 13, wherein determining the second pre-charging duration of the next row of sub-pixels according to the charging time of the sub-pixel with the maximum grayscale in the previous row of sub-pixels and the charging time of the sub-pixel with the minimum grayscale in the target row of sub-pixels comprises:
comparing the maximum grayscale of the previous row of sub-pixels with the minimum grayscale of the target row of sub-pixels;
determining the second pre-charging duration of each sub-pixel in the next row of sub-pixels to be the charging time of each corresponding sub-pixel in the previous row of sub-pixels, when the maximum grayscale of the previous row of sub-pixels is less than or equal to the minimum grayscale of the target row of sub-pixels; and
determining the second pre-charging duration of each sub-pixel in the next row of sub-pixels to be the charging time of the sub-pixel with the minimum grayscale in the target row of sub-pixels, when the maximum grayscale of the previous row of sub-pixels is greater than the minimum grayscale of the target row of sub-pixels.

15. The driving circuit of claim 9, wherein determining the grayscale of each sub-pixel in each row of sub-pixels, to obtain the charging time of each sub-pixel in each row of sub-pixels comprises:
determining a data voltage of each sub-pixel in each row of sub-pixels according to the grayscale of each sub-pixel in each row of sub-pixels; and
determining the charging time of each sub-pixel according to a pre-stored capacitance value of a storage capacitor of each sub-pixel in each row of sub-pixels, a power supply voltage of each sub-pixel in each row of sub-pixels, and a charging current of each sub-pixel in each row of sub-pixels.

16. The driving circuit of claim 15, wherein the charging time of each sub-pixel is determined according to the pre-stored capacitance value of the storage capacitor of each sub-pixel in each row of sub-pixels, the power supply voltage of each sub-pixel in each row of sub-pixels, and the charging current of each sub-pixel in each row of sub-pixels, by using the following formula:
$$t = ( V DD - V data ) \times C / I ,$$
where t is the charging time of each sub-pixel, VDD is the power supply voltage of each sub-pixel in each row of sub-pixels, Vdata is the data voltage of each sub-pixel, C is the capacitance value of the storage capacitor of each sub-pixel in each row of sub-pixels, and I is the charging current of each sub-pixel in each row of sub-pixels.

17. A display device comprising a display panel and a driving circuit, wherein the driving circuit is electrically connected to the display panel comprising a plurality of rows of sub-pixels and is configured to execute steps in a driving method for the display panel, to drive the display panel to display, the driving method comprising:
determining a grayscale of each sub-pixel in each row of sub-pixels, to obtain charging time of each sub-pixel in each row of sub-pixels; and
determining a first pre-charging duration of a target row of sub-pixels according to the charging time of each sub-pixel in a previous row of sub-pixels and the charging time of each sub-pixel in the target row of sub-pixels, wherein the first pre-charging duration is a duration for charging the target row of sub-pixels while charging the previous row of sub-pixels.

18. The display device of claim 17, wherein each sub-pixel in the previous row of sub-pixels is in one-to-one correspondence with each sub-pixel in the target row of sub-pixels, and determining the first pre-charging duration of the target row of sub-pixels according to the charging time of each sub-pixel in the previous row of sub-pixels and the charging time of each sub-pixel in the target row of sub-pixels comprises:
determining whether the grayscale of each sub-pixel in the previous row of sub-pixels is the same as the grayscale of each corresponding sub-pixel in the target row of sub-pixels;
determining the first pre-charging duration of each sub-pixel in the target row of sub-pixels to be the charging time of each corresponding sub-pixel in the previous row of sub-pixels, when the grayscale of each sub-pixel in the previous row of sub-pixels is the same as the grayscale of each corresponding sub-pixel in the target row of sub-pixels; and
determining the first pre-charging duration of the target row of sub-pixels according to charging time of a sub-pixel with a maximum grayscale in the previous row of sub-pixels and charging time of a sub-pixel with a minimum grayscale in the target row of sub-pixels, when a grayscale of a sub-pixel in the previous row of sub-pixels is different from a grayscale of a corresponding sub-pixel in the target row of sub-pixels.

19. The display device of claim 18, wherein determining the first pre-charging duration of the target row of sub-pixels according to the charging time of the sub-pixel with the maximum grayscale in the previous row of sub-pixels and the charging time of the sub-pixel with the minimum grayscale in the target row of sub-pixels comprises:
comparing the maximum grayscale of the previous row of sub-pixels with the minimum grayscale of the target row of sub-pixels;
determining the first pre-charging duration of each sub-pixel in the target row of sub-pixels to be the charging time of the sub-pixel with the maximum grayscale in the previous row of sub-pixels, when the maximum grayscale of the previous row of sub-pixels is less than or equal to the minimum grayscale of the target row of sub-pixels; and
determining the first pre-charging duration of each sub-pixel in the target row of sub-pixels to be the charging time of the sub-pixel with the minimum grayscale in the target row of sub-pixels, when the maximum grayscale of the previous row of sub-pixels is greater than the minimum grayscale of the target row of sub-pixels.

20. The display device of claim 17, wherein the driving method further comprises:
determining a second pre-charging duration of a next row of sub-pixels according to the charging time of each sub-pixel in the previous row of sub-pixels, the charging time of each sub-pixel in the target row of sub-pixels, and the charging time of each sub-pixel in the next row of sub-pixels, wherein the second pre-charging duration is a duration for charging the next row of sub-pixels while charging the previous row of sub-pixels.
